(19) United States
(12) Patent Application Publication
(10) Pub. No.: US 2017/0110016 A1
(43) Pub. Date: Apr. 20, 2017

(54) Indoor Autonomous Navigation System

(71) Applicant: Droneventory Corporation, San Diego, CA (US)

(72) Inventors: Melanie Amarasekara, San Diego, CA (US); Marc Allen Bernard, San Diego, CA (US)

(21) Appl. No.: 15/294,491

(22) Filed: Oct. 14, 2016

Related U.S. Application Data
(60) Provisional application No. 62/242,814, filed on Oct. 16, 2015.

(51) Int. Cl. G08G 5/00; H04W 4/02; B64C 39/02; H04W 4/04

(52) U.S. Cl. CPC G08G 5/0069; H04W 4/043; H04W 4/023; G08G 5/0034; B64C 39/024; B64C 2201/024; B64C 2201/108; B64C 2201/141; B64C 2201/146

(57) ABSTRACT

A system for autonomous navigation within an enclosed area is provided. The system can have a remote control station having a route management system operable to determine a flight plan. The system can further have a device configured for unmanned operation having a transceiver operable to receive the flight plan from the remote control station. The device can have a memory operable to store the flight plan and an electromagnetic (EM) map of the enclosed area. The device can have a location determination sensor (LDS) operable to determine a three dimensional position of the device within the enclosed area based on the EM map. The device can then execute the flight plan based on the three dimensional position and the EM map,

### CROSS-REFERENCE TO RELATED APPLICATION

The present application claims the benefit of U.S. Provisional Patent Application No. 62/242,814, “LOCATING AND AUTONOMOUS NAVIGATION SYSTEM FOR INDOOR USE,” filed Oct. 16, 2015 under 35 U.S.C. 119, the entirety of which is hereby incorporated by reference.

### TECHNICAL FIELD

The disclosure is related to navigation system for remote, autonomous, or semi-autonomous systems. More specifically, this disclosure relates to a three dimensional (3D) routing and navigation system for use indoors.

### BACKGROUND

Unmanned aerial systems (UAS) can make use of various navigation systems. For example, with systems such as Global Positioning System (GPS), Galileo, and Glonass, individuals and devices can readily determine position in three dimensions anywhere on earth, provided the locating system has an unobstructed connection with the satellites used to provide these services. Such a connection can require the device be in “line-of-sight” of such satellites. These navigation systems can be used most successfully when outdoors, however indoor use can be limited due to the absence of a line-of-sight connection with the satellites.

GPS, for one example, reception can be very limited when indoors due to the obstruction of the GPS signal when indoors. Accordingly, GPS is less reliable when, for example, inside a building. Therefore there is a need to expand navigation capabilities for remote, autonomous, or semi-autonomous systems (e.g., UAS) in indoor environments.

### SUMMARY

This disclosure is directed to navigation technology to support the deployment of UAS and other unmanned systems and devices in a broad array of indoor applications. Such a navigation system can include providing unmanned or robotic systems the ability to determine their location within an enclosed area facilitates the development of indoor routing and navigation capabilities for those systems.

This disclosure can enable the use of UAS and other robotic systems for indoor applications benefitting from autonomous navigation and 4-dimensional routing. Such applications can include, for example, facility security and inventory control among many other applications.

The disclosure can provide UAS and other robotic systems to navigate to waypoints and follow a predetermined route to a collection of waypoints and determine its own route to travel to a collection of waypoints based on starting point, obstacle avoidance, and efficiency.

As aspect of the disclosure provides a system for autonomous navigation within an enclosed area. The system can have a remote control station. The remote control station can have a route management system operable to determine a flight plan, the flight plan having a route template, a route schedule, and one or more route instances. The remote control station can also have a memory operable to store the flight plan. The remote control station can also have a remote controller coupled to the receiver and the memory. The system can also have a device configured for unmanned operation. The device can have a transceiver operable to receive the flight plan from the remote control station. The device can also have a memory operable to store the flight plan and an electromagnetic (EM) map of the enclosed area. The device can also have a location determination sensor (LDS) operable to determine a three dimensional position of the device within the enclosed area based on the EM map. The device can also have a device controller coupled to the LDS, the transceiver, and the memory, the device controller operable to execute the flight plan based on the three dimensional position and the EM map.

Another aspect of the disclosure provides . . . .

Other characteristics and advantages will become apparent with a review of the following detailed description.

### BRIEF DESCRIPTION OF THE DRAWINGS

The following is a brief description of the accompanying drawings, wherein like numbers refer to like features and characteristics throughout the following Detailed Description, and wherein:

FIG. 1 is a functional block diagram of a four dimensional autonomous navigation system (ANS);

FIG. 2 is a functional block diagram of an embodiment of a battery profile translator of FIG. 1; and

FIG. 3 is a diagram of an embodiment of data fields within the data structures usable with the automatic navigation system of FIG. 1.

### DETAILED DESCRIPTION

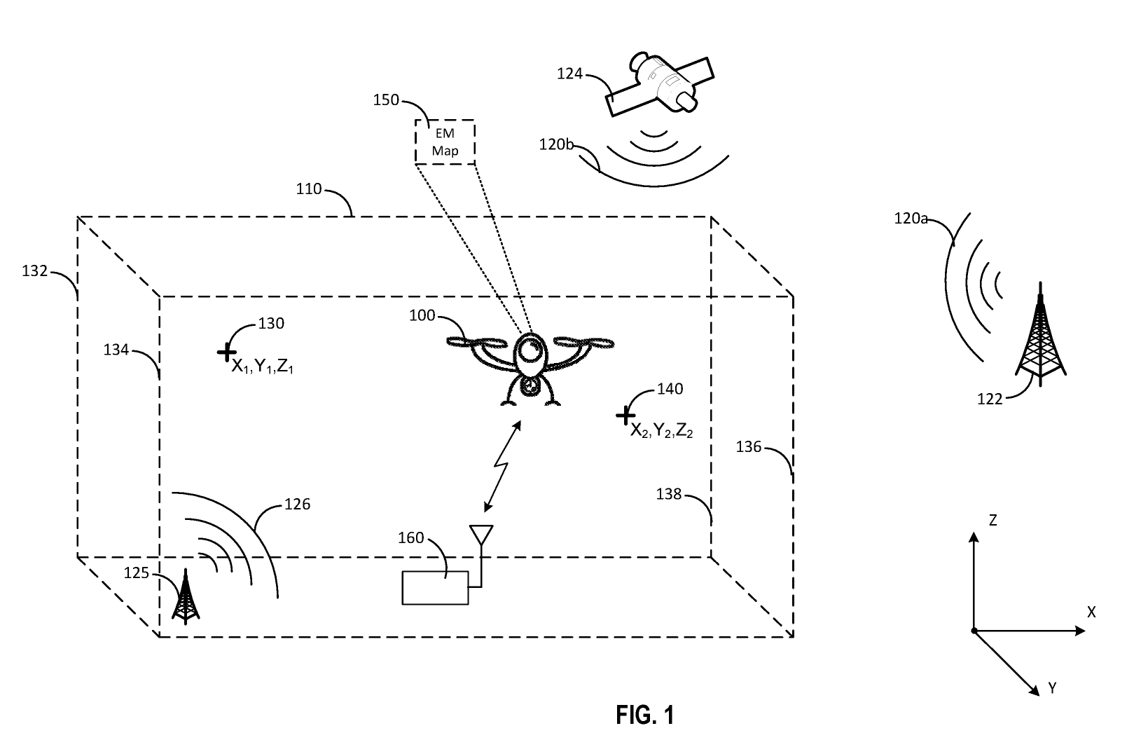

FIG. 1 is a graphical representation of a navigation system for unmanned aerial systems. A system 10 can have a device 100 configured for remote, autonomous, or semi-autonomous flight. Thus, the system can be adapted for autonomous navigation.

The device 100 can be, for example, a UAS or other remote, autonomous, semi-autonomous, or robotic system. The device 100 can be situated in a three dimensional (3D) space 110. The 3D space 110 can be an enclosed or semi-enclosed area. The device 100 can further communicate with a remote control station 160. The remote control station 160 can exchange data, information, and commands with the device 100 related to flight operations or specific tasking for the device 100. Communication between the device 100 and the remote control station 160 can be done via various wireless communication standards as described herein.

The 3D space 110 is depicted as a three dimensional box, though the shape of the 3D space should not be considered limiting. The edges of the 3D space 110 are represented as dashed lines. The 3D space 110 may be referred to in terms of a 3D Cartesian coordinate plane, as shown in the lower right of FIG. 1, indicating an X-axis, a Y-axis, and a Z-axis.

The 3D space 110 can be any enclosed or partially enclosed space having a ceiling or one or more walls. In some embodiments, the 3D space 110 is a building, a warehouse, or similar structure forming an enclosed space. In some embodiments, the interior of the 3D space 110 can be at least partially isolated from certain radiofrequency (RF) transmissions 120a from a terrestrial antenna 122 (associated with RF transmissions 120a) or RF transmissions 120b (associated with a satellite 124). The RF transmissions 120a can be from, for example, a radio tower, a microwave tower, a cellular tower, or any other transmitter that radiates RF energy, while the RF transmissions 120 can be associated with satellite communications or certain navigation systems, such as GPS, for example. The RF transmissions 120a, 120b can be collectively referred to herein as RF transmissions 120.

Both the tower 122 and the satellite 124 are disposed on the exterior of the 3D space 110. Therefore in some embodiments, the associated RF transmissions 120 from the tower 122 or the satellite 124 may be partially or totally attenuated by the structure of the 3D space 110. Accordingly, systems disposed on the interior of the 3D space 110 may not receive a usable version of the RF transmissions 120. In some other embodiments, the RF transmissions 120 may penetrate the 3D space 110 and thus be usable, but possibly have questionable reliability. This can make using GPS or a mobile communication device (e.g., cellular phone or other mobile electronic device) difficult or frustrating given the weak signals present in the interior of the 3D space 110. Navigation using GPS, for example, is then potentially questionable or unreliable indoors.

In some embodiments, the 3D space 110 can have certain physical characteristics, given the surrounding environment. For example, a building (e.g., the 3D space 110) can have internal support structures, having wooden or metallic support members, metal walls (e.g., corrugated metal or similar), metallic mesh embedded within plaster, or other materials that affect the transmission of various forms of energy. For example, a metal mesh inside a plaster or sheet rock wall can act like a Faraday cage, limiting the transmission of the RF transmissions 120 through the walls, Metallic components within the building can reflect RF transmissions and/or affect or distort the earth's natural magnetic fields. Often such electromagnetic distortions are measurable within the 23D space.

In some embodiments, the 3D space 110 can have outer limits. As shown, the 3D space can have a first corner 132, a second corner 134, a third corner 136, and a fourth corner 138. While a rectangular prism is used as a primary example in this figure, the description of the 3D space 110 can apply to any shaped 3D space.

The electromagnetic (EM) distortions within the 3D space 110 can naturally vary along the walls and throughout the space between the first corner 132, the second corner 134, the third corner 136, and the fourth corner 138. In some examples, the EM variations can vary slowly, remaining within a small tolerance over time. In some other examples, the EM variations within the 3D space 110 can vary more quickly.

Depending on how fast or often such EM characteristics vary throughout the 3D space 110, such characteristics can be measured and mapped. Thus a 3D map of EM variation throughout the 3D space 110 can be derived. Such a map may be referred to herein as a “3D EM map.” In some embodiments, a 3D EM map 150 can be stored in memory of the device 100 and used for navigation within the 3D space 110.

In some embodiments, the 3D EM map 150 can be structured as a representation of the 3D space 110, separated into smaller portions or sectors. The sectors can completely subdivide the 3D space 110 into cubes, cuboids, prisms, or other three dimensional forms that can subdivide the 3D space 110. Each of the cubes can have a center point that represents a three dimensional location within the 3D space (e.g., the first location 130 and the second location 140). The center point of each sector can then be used as a waypoint for navigating within the 3D space using the 3D EM map 150. The dimensions of each sector can vary with a sweep width of the sensor used to create the 3D EM map 150. The dimensions of each sector can then affect the resolution or precision of the 3D EM map 150.

One such 3D map can be a map of the magnetic field variation throughout the 3D space 110. Such a 3D map can be based on measurements of ambient magnetic field within the 3D space 110. Given a fixed structure or building, such as the 3D space 110, the earth's magnetic field may vary throughout the 3D space 110 with little variation over time. The magnitude of the magnetic field within the 3D space 110 can be mapped. Then measurements within the 3D space 110 can be compared to the map to provide a three dimensional position within the 3D space 110.

In some other examples, one or more transmitters 125 can be disposed within the 3D space 110. The transmitters 125 emit RF radiation 126 having predetermined characteristics, such as frequency, wavelength, or power level. The RF radiation 126 from the one or more transmitters 125 can form a grid, of sorts, traversing the interior of the 3D space. The RF radiation 126 can have a predictable and measureable variation throughout the 3D space 110 that can be used to derive a position within the 3D space 110.

Thus, in either of the foregoing examples, an EM measurement take at, for example, a first location 130 (at coordinates X₁, Y₁, Z₁) within the 3D space 110 can have specific characteristics, such as a magnitude and a direction. Similarly, a measurement taken at a second location 140 (at coordinates X₂, Y₂, Z₂) can have other specific characteristics. In some examples, the measurements may be different or distinct allowing identification of a precise location on a 3D EM map. In some other examples, the measurements taken at the first location 130 and the second location 140 may be similar. In such an example, the variation in the EM fields (e.g., of the natural, magnetic field or the RF radiation 126) between the first location 130 and the second location 140 can be used to identify a location on the 3D EM map. Variations in the EM map of the 3D space 110 can then be used to navigate from, for example the first location 130 to the second location 140.

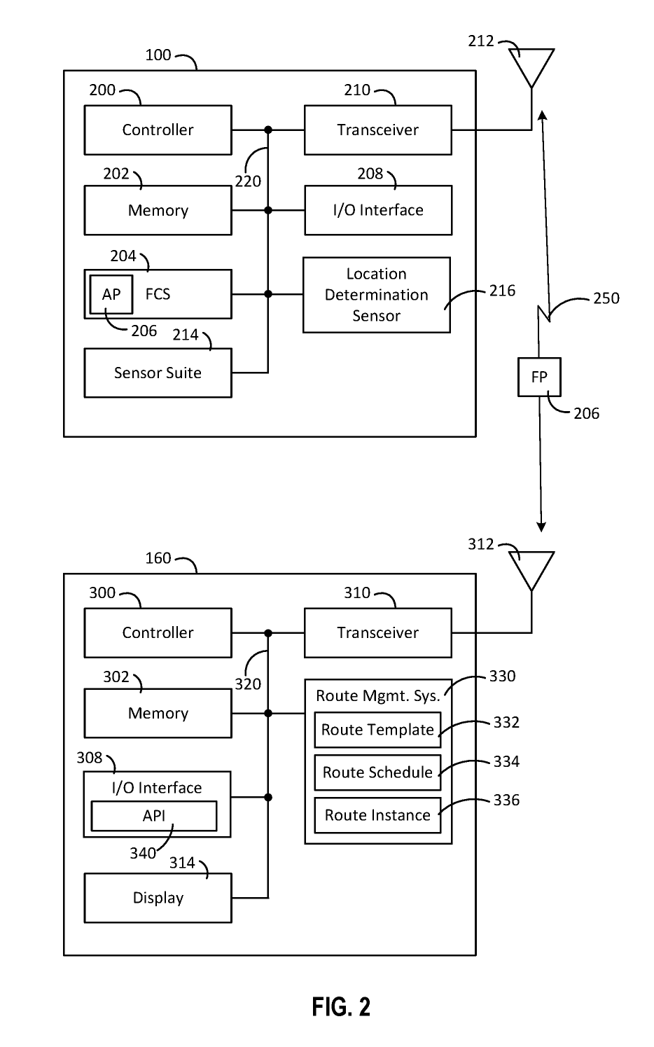

FIG. 2 is a functional block diagram of an embodiment of the device 100 of FIG. 1. The device 100 can have a device controller (controller) 200. The controller 200 can perform functions for the overall control of the device 100. The controller 200 can have a central processing unit (CPU) having one or more processors. The controller 200 can implement certain navigation and routing capabilities of the device 100. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the controller 200.

The controller 200 can be connected to a communication bus 220. The communication bus 220 may include a data channel for facilitating information transfer between storage and other peripheral components of the device 100. The communication bus 220 may further provide a set of signals used for communication with the controller 200, including a data bus, address bus, and control bus (not shown). The communication bus 220 can have any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

The device 100 can have a memory 202 coupled to the controller 200 via the communication bus 220. The memory 202 can be one or more memories operable to store information related to the operations of the device 100. For example, the memory 202 can store the 3D EM map 150. The memory 202 can have electronic storage that can serve as a repository for instructions, software code, and/or other implementing the algorithms that the controller 200 can use to execute various instructions for control of the device 100.

The memory 202 can provide storage of instructions and data for programs executing on the controller 200. The memory 202 can be a semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The memory 202 can also optionally include an internal memory and/or a removable medium, for example a floppy disk drive, a magnetic tape drive, a compact disc (“CD”) drive, a digital versatile disc (“DVD”) drive, etc. The removable medium is read from and/or written to in a well-known manner.

The memory 202 can be a non-transitory computer readable medium having stored thereon computer executable code (i.e., software) and/or data. The computer software or data stored on the memory 202 is read into the device 100 for execution by the controller 200.

In this description, the term “computer readable medium” may be used to refer to any non-transitory computer readable storage media used to provide computer executable code (e.g., software and computer programs) to the device 100. These non-transitory computer readable mediums are means for providing executable code, programming instructions, and software to the device 100.

In some embodiments, the memory 202 can have other similar means for allowing computer programs or other data or instructions to be loaded into the device 100. Such means may include, for example, an external storage medium and an interface 208. Examples of external storage medium may include an external hard disk drive or an external optical drive, or and external magneto-optical drive. Other examples of external memory may include semiconductor-based memory such as programmable read-only memory (“PROM”), erasable programmable read-only memory (“EPROM”), electrically erasable read-only memory (“EEPROM”), or flash memory (block oriented memory similar to EEPROM).

The device 100 can also have an input/output (“I/O”) interface 208 coupled to the communication bus 220. The I/O interface 208 can enable input from and output to and from external devices

In some embodiments, the I/O interface 208 can further allow, for example, computer software or executable code to be transferred to the device 100 from a network server. For example, the I/O interface 208 can couple to a modem, a network interface card (“NIC”), a wireless data card, a communications port, a PCMCIA slot and card, an infrared interface, and an IEEE 1394 fire-wire to enable information or data transfer to the controller 200 and/or the memory 202.

The I/O interface 208 and the controller 200 can implement industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

In some embodiments, the I/O interface 208 can receive input from a peripheral device (e.g., a keyboard, mouse, or external programming device) and can provide output to the controller 200 or, for example, an external display. The I/O interface 208 is capable of facilitating input from and output to various alternative types of human interface and machine interface devices alike.

The device 100 can have a transceiver 210. The transceiver 210 can be a communication interface allowing data and information to be exchanges between the device 100 and external devices.

The transceiver 210 can support transmit and receive functions via one or more antennas 212. The transceiver 210 can be one or more transmitters and one or more receivers as required. The antennas 212 can be a part of a directional or omnidirectional antenna array of the transceiver 210 that can support one or more wireless transmission protocols. For example, the device 100 (e.g., the controller 200) can communicate over one or more 802.11-family WiFi protocols, Bluetooth, one or more various cellular transmission protocols (CDMA, LTE, etc.), or similar wireless technologies.

The device 100 can communicate with the remote control station 160. The remote control station 160 can be a control station or similar operable to transmit and receive data and information or provide commands to the device 100 regarding specific flight instructions to a specific location or to follow a specified route over a period of time. In some embodiments, the remote control station 160 can transmit one or more flight plans (flight plan) 180 to the device 100. The flight plan 180 can have a set of instructions the device 100 is to follow. The flight plan 180 can have a series of waypoints and other instructions programmed at the remote control station 160.

The device 100 can have a flight control system (FCS) 204 coupled to the communication bus 220. The FCS 204 can control, for example, one or more control surfaces of the device 100 and how and to where the device maneuvers. For example, a device 100 embodied as a UAS, the FCS 204 can command the thrust inputs, rotors, propellers, ailerons, or other control surfaces that allow flight and control of device 100. The FCS 204 can also have or be associated with an autopilot (AP) 206. The AP 206 can perform flight operations with the FCS 204 based on the EM map 150 can commands from the controller 200.

In some embodiments, the FCS 204 (or the controller 200) can reference the 3D EM map 150 stored to the memory 202 for navigation and maneuvering in three dimensional space. The memory 202 can store the one or more flight plans 180 or waypoint databases received via the transceiver 210 and saved by the controller 200 or preprogrammed to the memory via the I/O interface 208. Such waypoints or flight plans can referenced to mapped locations on the 3D map 150 corresponding to the same locations in the 3D space 110.

The device 100 can have a sensor suite 214. The sensor suite 214 can have, for example one or more cameras. The sensor suite can also have one or more of a RF identification (RFID) reader, an ultrasonic sensor (e.g., a transmitter and/or a receiver), and a laser sensor (e.g., a laser transmitter or receiver). The sensor suite 214 can have CMOS camera designed for detecting visible light. The sensor suite 214 can further have an infrared camera, a low-light camera, or be adapted as a night vision device (NVD). The sensor suite 214 can provide still images or video of the environment within the 3D space 110 as needed. Other sensors are also possible for use with the sensor suite 214.

The device can also have a location determination system (LDS) 216. The LDS 216 can be coupled to the communication bus 220. The LDS 216 can be a sensor configured to provide a location of the device 100 to the controller 200. The controller 200 can then reference the flight plan 180, and in conjunction with the FCS 204, maneuver the device 100 from one waypoint to another waypoint. For example, the LDS 216 can fix the device at the first location 130, for example, allowing the controller 200 and the FCS 204, the device 100 can maneuver to the second location 140 (or another waypoint) according to the flight plan 180.

In some embodiments, the LDS 216 can be a replacement for an onboard GPS receiver, for example. The LDS 216 can further be a one-for-one, or after-market replacement with an onboard GPS receiver within the device 100. Such an LDS 216 can be operable to communicate with the controller 200 in a similar fashion to a native GPS receiver within the device 100. In some other embodiments, the LDS 216 can be a sensor fitted within the device 100 in addition to a GPS receiver, and coupled to the communication bus 220.

In some embodiments, the LDS 216 can have a sensitive, three-axis sensor for fixing a location of the device 100. For example, such a sensor can be one or more RF receivers. The one or more RF receivers can be a single antenna or multiple antennas arranged in an array (e.g., a phased array) that can determine an angle of arrival of various RF transmissions and triangulate the position of the device 100. In some other embodiments, the LDS 216 can have a magnetometer to measure variations in the magnetic field (e.g., field strength) within the 3D space 110. The LDS 216 can also have a GPS receiver.

The LDS 216 can communicate the location information to the controller 200. The controller 200 can compare the location with the 3D EM map 150 in the memory 202 to determine a location of the device 100. The 3D EM map 150 can have measurements of the ambient magnetic field throughout the 3D space 110. Through this process, the device 100 can determine its location within one centimeter (cm) or 10 millimeters (mm). In some embodiments, the accuracy of the location provided by the LDS 216 can be 5-10 mm. The precision can depend on the accuracy of the measurements taken to create the 3D EM map 150. For example, the sectors of the 3D EM map 150 can be approximately 1 cm cubes. Therefore the center points of each sector (e.g., waypoints) can be approximately 1 cm apart, providing the desired precision and accuracy. In some embodiments, the sectors can be smaller or larger than 1 cm as needed for a specific application.

In some embodiments, the measurements provided by the LDS 216 can be converted (by, e.g., the controller 200 and/or the LDS 216) to longitude, latitude, and altitude. The conversion can be supplied to, or used by the controller 200 and the FCS 204 for navigation within the 3D space 110. This can allow the device to implement the LDS 216 as it would a standard GPS receiver. Accordingly, in some embodiments, the LDS 216 can integrate with the device 100 with no modification required to the device 100.

In some other embodiments, the position or location information sensed or determined by the LDS 216 can be converted to other coordinate systems, such as, for example, the National Marine Electronics Association (NMEA) 0183 or NMEA 2000 formatted data for use by the device 100 should it require certain coordinate systems.

The device 100 (e.g., using the transceiver 210) can communicate via a wireless communications system (WCS), 250. The WCS 250 can allow the device 100 to communicate with the remote control station 160. The WCS 250 can implement one or more wireless communication technologies, for example. In some embodiments, the WCS 250 can use an industry standard TCP/IP communications protocol and/or one or more other wireless technologies such as cellular or the IEEE

The remote control station 160 can have a remote controller (controller) 300, similar to the device controller 200. The controller 300 can further be coupled to a communication bus 320, similar to the communication bus 220. The remote control station 160 can further have a transceiver 310 and one or more antennas 212, similar to the transceiver 210 and the one or more antennas 212, described above in connection with the device 100.

The remote control station 160 can also have a route management system (RMS) 330. The RMS 330 can, along with the controller 300, allow creation, management, and reporting of the one or more flight plans 180. The route defined by the flight plan 180 can be a route of flight for the device 100 within the 3D space, for example. Each route in the flight plan 180 can have a route template 332, defining a relationship between a plurality of waypoints that form a route of flight. The route template 332 can have a route template geometry that can have a plurality of sectors (e.g., adjoining sectors) that can determine an entry and exit of a given sector as the device 100 flies along the route.

The RMS 330 can also create and manage a route schedule 334 (e.g., indicated in the flight plan 180), determining the time at which the device 100 will be at a given waypoint at a specific time. The route schedule 334 defines a relationship between time and the route template 332 for the device 100. The route schedule 334 can thus define a speed of the device 100.

The RMS 330 can also have or determine one or more route instances 336 for the flight plan 180. The route instances 336 can contain instructions or commands to the device 100 to perform a specific action at a given time or place (e.g., waypoint) along the route of flight. The route instances 336 can also contain instructions for the device 100 to travel to the waypoints specified in the route instance 336 in the most efficient manner as determined by the controller 200. The route instance 336 can further instruct the device 100 to provide certain data related to the commanded action(s). For example, the route instance 336 can command the device 100 to view a specific item at the first location 130 and send a still image or video of the item to the remote control station 160.

In some embodiments, the route instance 336 can also contain instructions for the controller 200 to save (to e.g., the memory 202) certain performance data related to the tasks identified by the route instance 336. The performance data can include, for example, indications of whether or not and when the device 100 arrives at a given waypoint, whether or not the sensors were successfully employed, whether the device 100 has performed required maneuvers at the specified time/waypoint (e.g., the device rotated 260 degrees for scanning at a waypoint), and whether the desired data was collected by the sensor systems.

In some embodiments, the remote control station 160, using the RMS 330 can provide the flight plan 180 and schedule to the device 100 (e.g., the AP 206) for tasks having specific instructions along the route of flight, allowing the device 100 to operate autonomously within the 3D space 110.

In some embodiments, a given flight plan 180 can have a plurality of waypoints described by the route template 332. The route schedule 334 can define that speed with which the device 100 may execute the route template. Each route template 332 can be associated with one or more route instances 336. The route instances 336 define a command or an action required by the device 100 upon arrival at the waypoint.

For example, when the device 100 (e.g., the controller 200) receives a route instance 336 associated with a flight plan, the FCS 204 and AP 206 navigate the device 100 to the specified location for the action associate with the route instance 336. In some embodiments, the controller 200 can set a timer to trigger at the scheduled start time of the route instance 336. Expiration of the timer indicates a time for the execution of the action.

A route instance 336 can include, for example, a command that the device 100 employ the sensor suite 214, to record a still image or a video clip at a specific time, location, or waypoint. The route instance 336 can further use the sensor suite 214 to track the location of an item equipped with an RFID tag. For example, RFID tags can be suited for use with inventory management in a warehouse. The device 100 have the sensor suite equipped with an RFID tracker can aid in the location of such items. Such a command can also include instructions for employment of the sensor suite 214, such as, for example, zoom, aperture, focus, antenna number, transmission strength, traversal, aim point, etc.

Following the execution of the route instance 336, the device 100 can navigate to the next waypoint defined by the route template 332.

Once the sensor employment is complete the controller 200 can store the data associated with the route instance 336 to the memory 202. The controller 200 can also transmit such collected data to the remote control station 216 or another location as required. The controller 200 can then indicate the status of the route instance 336 as completed. Such completion can also include recording a time of completion for the route instance 336.

The remote control station 160 can also have an I/O interface 308 similar to the I/O interface 208. The I/O interface 308 can also provide an application-program interface (API) 340. The API 340 can have a programmatic interface to the communication bus 220 and the other components of the device 100. The API 340 can be implemented using industry standard definitions for Web Services such as SOAP and REST. The API 340 can support Create, Read, Update and Delete operations on the data structures included in the memory 302 and other features, including the RMS 330.

In some embodiments, the API 340 can further having provisions allowing third party systems to retrieve and manipulate (e.g., create, modify, delete) data contained in the RMS 330, such as the route templates 332, the route schedules 334, and the route instances 336.

The remote control station 160 can also have a display 314 coupled to the communication bus 320. The display 314 can allow a user to view, add, and edit information for use by the RMS 330. The display 314 can further allow viewing, recording, and playback of images and video captured by the sensor suite 214 of the device 100.

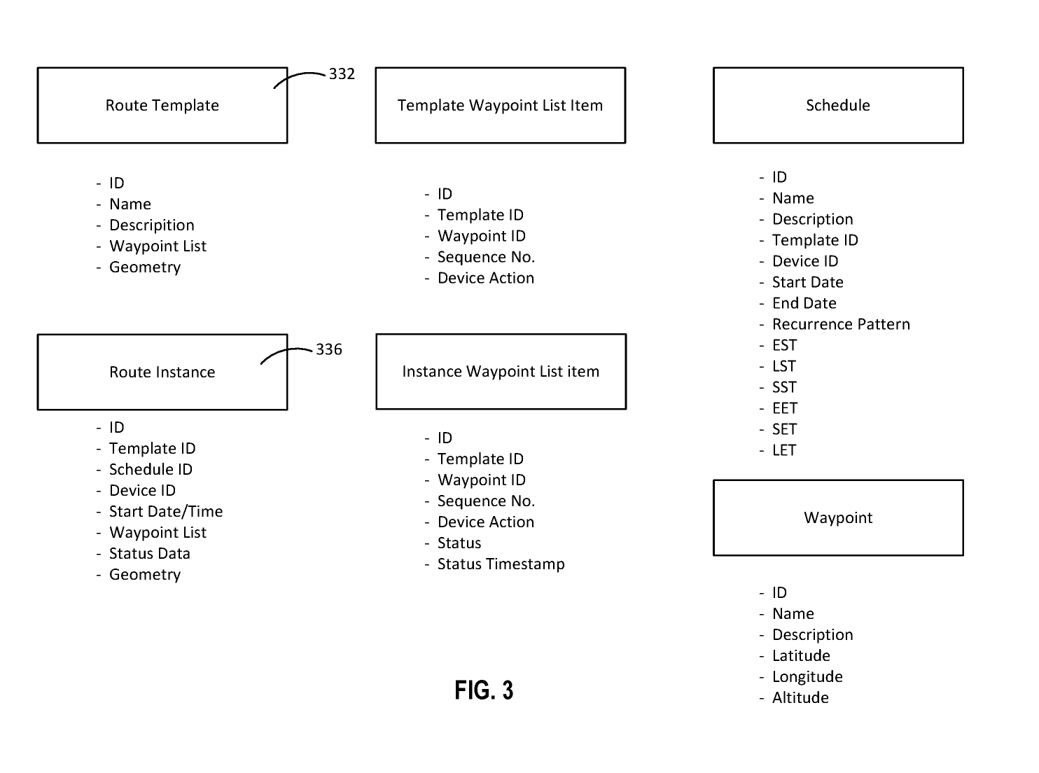

FIG. 3 is a diagram of an embodiment of data fields within the data structures usable with the automatic navigation system of FIG. 1 and FIG. 2. In some embodiments, the route template 332 can be a data structure defining the relationship between a collection of waypoints within the flight plan 180. Such a relationship can include a sequence of the waypoints as it relates to the device 100, an indication of specific sectors (or, e.g., cuboids) in which the device 100 is to implement its sensors, and specific instructions for deployment of one or more sensors. The route template 332 can also identify a name of the template and creation/modification data as needed.

In some embodiments, the route schedule 334 can associate the device 100 (e.g., a UAS or other robotic device), a sensor system (e.g., the sensor suite 214), the route template 332, and a date and time. The route template 332 can then be used by the controller 200 to execute or perform the route instance 336. The route schedule 334 can also include a date and time that the flight plan 180 should be executed by the device 100. The route template 332 can also have a recurrence pattern that can indicate to the controller 200 that certain route instances 336 are to be performed at regular intervals (e.g., such as daily, weekly or monthly) by the device 100. In some embodiments, there can be a one-to-many relationship between route template 332 and one or more route schedules 334. This can allow a single route template 332 to be executed on a regular or semi-regular basis.

In some embodiments, the route instance 336 can have a data structure including instructions to the device 100 (e.g., the controller 200) to execute a route identified in the route template 332. The route instance 336 can also indicate to the controller 200 to collect data (e.g., the performance data) from, for example, the sensor package(s) installed on the device 100 (e.g., the sensor suite 214) and the LDS 216 the device 100 executes the flight plan 180. The performance data is transmitted by the ANS to the RMS as it is collected,

In addition, the remote control station 160, in connection with the controller 300 and the RMS 330, can perform analysis to provide real-time status (e.g., work completed, exceptions, etc.) of the device 100. This information can be stored to the memory 302, propagated to third-party systems via the API 340, or displayed on the display 314.

Various embodiments may also be implemented primarily in hardware using, for example, components such as application specific integrated circuits (“ASICs”), or field programmable gate arrays (“FPGAs”). Implementation of a hardware state machine capable of performing the functions described herein can also be apparent to those skilled in the relevant art. Various embodiments may also be implemented using a combination of both hardware and software.

Furthermore, those of skill in the art can appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in any following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

I claim:

1. A system for autonomous navigation within an enclosed area, the system comprising:
a remote control station having
a route management system operable to determine a flight plan, the flight plan having a route template, a route schedule, and one or more route instances,
a memory operable to store the flight plan, and
a remote controller coupled to the receiver and the memory; and
a device configured for unmanned operation having
a transceiver operable to receive the flight plan from the remote control station,
a memory operable to store the flight plan and an electromagnetic (EM) map of the enclosed area,
a location determination sensor (LDS) operable to determine a three dimensional position of the device within the enclosed area based on the EM map, and
a device controller coupled to the LDS, the transceiver, and the memory, the device controller operable to execute the flight plan based on the three dimensional position and the EM map,

2. The system of claim 1, wherein the route template defines one or more waypoints in the flight plan.

3. The system of claim 2 wherein the route schedule defines a relationship between time and the one or more waypoints of the route template.

4. The system of claim 1 wherein the one or more route instances define tasks to be performed by the device during execution of the flight plan.

5. The system of claim 1, wherein the device controller is operable to communicate with the remote controller via a wireless connection.

6. The system of claim 1, wherein the EM map defines a three dimensional model of the enclosed area using measurements of ambient EM characteristics throughout the enclosed area.

7. The system of claim 6, wherein the EM characteristics comprise at least one of a measurement of variations in an ambient magnetic field within the enclosed area, and measurements of variations in an ambient radio frequency characteristics within the enclosed area.

8. The system of claim 1, wherein the EM characteristics comprise measurements of an ambient magnetic field throughout the enclosed area, and wherein the LDS comprises a magnetometer, that in conjunction with the device controller, is operable to determine, based on the EM map, a three dimensional position of the device within the enclosed area.

9. A method for autonomous navigation within an area at least partially isolated from external radiofrequency transmissions, the method comprising:
receiving, at a device configured for unmanned operation, a flight plan from a remote control station having a route management system, the flight plan indicating a route of flight and defining one or more tasks for performance by the device along the route of flight;
determining, by the device, a location of the device in three dimensions within the area using a location determination sensor (LDS) and an electromagnetic (EM) map of the area, the EM map being based on variations of ambient EM measurements throughout the area;
navigating the route of flight based on the location of the device and the EM map; and
executing the one or more tasks based on the flight plan.

10. The method of claim 9 wherein the route management system provides the flight plan, the flight plan comprising:
a route template defining one or more waypoints;
a route schedule defining a relationship between time and the waypoints; and
a route instance defining the one or more tasks associated with the waypoints.

11. The method of claim 9 further comprising reporting information related to the one or more tasks to the remote control station.

12. The method of claim 9, wherein the LDS is a replacement for a global positioning receiver in the device.

13. The method of claim 9, wherein the EM map comprises measurements of an ambient magnetic field within the area to define a three dimensional model of the area.

14. The method of claim 12, wherein the LDS comprises a magnetometer operable to determine a measurement of the ambient magnetic field surrounding the device, and wherein the determining comprises comparing the measurement of the ambient magnetic field to the EM map.
